(19) United States
(12) Patent Application Publication
(10) Pub. No.: US 2016/0027129 A1
(43) Pub. Date: Jan. 28, 2016

(54) METHOD AND SYSTEM FOR RATING ENTITIES WITHIN A PEER NETWORK

(71) Applicant: Professional Passport Pty Ltd, Malvern (AU)

(72) Inventors: Paul PALLAGHY, Melbourne (AU); Jonathan MOR, Melbourne (AU)

(21) Appl. No.: 14/807,210

(22) Filed: Jul. 23, 2015

(30) Foreign Application Priority Data
Jul. 24, 2014 (AU) 2014902874

(51) Int. Cl. G06Q 50/00

(52) U.S. Cl. CPC G06Q 50/01

(57) ABSTRACT

A method of providing a rating for an entity within a network of entities comprises receiving, from a ratee entity requiring a rating, a message including a nomination of one or more rating entities. Each nominated rating entity may be presented with a request to respond to a set of questions in relation to the ratee entity. Each response can be selected from a corresponding rating scale. Resulting response scores on the rating scale are subsequently received from the rating entities. A qualification measure is computed for each of the rating entities. The qualification measure may comprise a capability measure, a bias measure and/or a familiarity measure. For each rating entity, a rating score is computed for the ratee entity based upon the response scores and the qualification measure of the rating entity. An overall rating score of the ratee entity is then computed based upon the individual rating scores.

### CROSS REFERENCE TO RELATED APPLICATIONS

This application claims the benefit of Australian provisional patent application no. 2014902874, filed on 24 Jul. 2014, which is incorporated herein in its entirety by reference.

### FIELD OF THE INVENTION

The present invention relates to rating and ranking systems, and more particularly to improving the quality of ratings provided within peer-to-peer-type networks, in which entities can act both as providers and recipients of ratings, i.e. as raters and ratees. One application of the invention is in professional networks, wherein members of the network may desire ratings or references to be provided by other members of the network, e.g. by former or current work colleagues, and by the same token may be called upon to provide ratings or references for others.

### BACKGROUND TO THE INVENTION

In recent years, there has been a proliferation in peer-to-peer-type social and professional network platforms deployed via the Internet. Some of the best known, and most widely utilized, of these platforms include Facebook, Twitter, Linked In, Google+, Instagram, Pinterest, and so forth. In many respects, platforms such as Craigslist (classified advertisements), eBay (online auctions and stores), Freelancer.com (freelancing platform) and sharing platforms such as Uber (ride sharing) and Airbnb (accommodation) can also be regarded as peer-based networks, in that all members can act as consumers and/or providers of goods, services and information.

Most of these platforms provide mechanisms whereby network members can ‘rate’, or otherwise assess, characteristics of other members, such as quality, performance, reliability, interest and so forth. Examples of such mechanisms include Facebook ‘like’, Twitter ‘favorites’, eBay's rating system and feedback scores, Google's ‘+1’ system, and LinkedIn's ‘endorsements’ mechanisms. All of these systems are generally able to provide some indication as to whether a network member, their goods, services and/or content, are generally positively regarded. Some (such as eBay's rating system, and Freelancer.com) also allow negative feedback to be recorded and reflected. A limitation of all of these mechanisms, however, is the difficulty of determining whether positive ratings have been genuinely earned, and are the result of positive feedback by experienced and knowledgeable rating providers, or are the result of some less-reliable form of feedback. For example, it is well-known that it is possible to buy Twitter followers and Facebook ‘likes’, and other forms of positive feedback on various peer-to-peer networking platforms. LinkedIn endorsements are often provided as a result of the ease of doing so, and/or in the expectation or hope of receiving similar endorsements in return. On Freelancer.com users may give each other artificially good, even perfect, ratings because: (i) users know these ratings will be visible after reciprocal ratings are achieved; and (ii) users may want to work with each other again despite less than perfect performance.

Many existing rating systems therefore lack any mechanism to assess the quality of ratings and raters, or any significant disincentive for ratings to be provided in a generally indiscriminate manner.

There have been some attempts in the prior art to address this issue. For example, U.S. Pat. No. 6,895,385, issued on 17 May 2005 to Giorgos C Zacharia et al, and assigned to Open Ratings, discloses a number of existing and improved rating systems, in which the raters are subject to assessment that affects the impact of their ratings upon the scores allocated to ratees. In one system described by Zacharia, and attributed to Sporas, the rating of a ratee depends upon the reputation of each of their raters. Reputation is itself the net effect of all ratings provided to the respective raters. In an alternative approach, attributed by Zacharia to Histos, the rating of a ratee depends upon a closeness of association between each rater and the ratee within the peer network. In particular, the rating score attributed to a ratee depends upon the reputation of all entities within the peer network making up a path of rater-ratee relationships linking the original rater to the final ratee.

Zacharia identifies a limitation of both Sporas and Histos, in that both employ only a single reputation value, and thus fail to account for the possibility that somebody with a positive reputation for the skills or services being rated may not be an equally good rater of other entities. Zacharia thus introduces a distinction between the usual measure of reputation within the particular network and a separate reputation as a rater of other entities within the network. This rater reputation is determined by comparing the rating given by the rater to a ratee with ratings given by other raters to the same ratee. In essence, a rater identified as an ‘outlier’, in the sense of providing distinctly different ratings from what is typical, will tend to gain a reduced reputation as a rater.

Zacharia's approach is targeted particularly at homogeneous networks, or communities, of raters and ratees. For example, Zacharia's approach may be beneficial in an online market in which all members are sellers and/or purchasers of goods and services, and there is a broad agreement regarding desirable characteristics of raters and ratees. In this example, the primary desirable characteristic of a ratee may be quality/reliability of service, whereas the primary desirable characteristic of a rater may be trustworthiness, i.e. the extent to which their assessment of ratees can be regarded as a reliable indicator of quality/reliability of service. Thus, although Zacharia provides for separate reputation scores, both can be regarded as measures of trust in their specific domain of application.

In other contexts, however, trust may not be the only—or even most important—characteristic to be accounted for in evaluating the reliability and relevance of a rating provided by a particular rater to a particular ratee. Furthermore, the community may not be homogeneous, such that the reputation of a rater in relation to a subset of one or more ratees may not be accurate when considering the same rater's reputation in relation to a distinct subset of ratees.

One such example is a professional context, in which raters may act as referees for ratees who are under consideration for one or more employment roles. Assuming that a majority of professional referees can be trusted to provide an honest appraisal of a candidate, which is particularly likely to be the case when referees are unable to remain anonymous, the more immediate problem in comparing ratings of different ratees is how to account for each rater's (i.e. referee's) capability to assess a candidate across a range of different criteria, each of which may be of variable importance, depending upon the nature of a particular role.

Furthermore, in a professional context of this kind, candidates will typically nominate/select their own referees, which represents a different circumstance from the communities addressed by Zacharia, in which ratings may generally be provided spontaneously between all members of the peer network.

Accordingly, there remains a need for more advanced and improved methods and systems for providing ratings of entities within networks of such entities, to enable greater nuance and improved reliability of the ratings provided to ratee entities. Embodiments of the present invention are intended to address this ongoing need.

### SUMMARY OF THE INVENTION

In one aspect, the invention provides a method of providing a rating for an entity within a network of entities, the method comprising:

receiving, from a ratee entity requiring a rating, a message comprising a nomination of one or more rating entities;

presenting to each of said one or more rating entities a message comprising a request to respond to a plurality of questions in relation to the ratee entity, each said question requiring a response according to a rating scale;

receiving, from each of said one or more rating entities, a corresponding response, each response comprising a plurality of response scores corresponding with the plurality of questions, each response score being in accordance with the rating scale;

computing a qualification measure for each of said rating entities, the qualification measure comprising one or more of a capability measure, a bias measure and a familiarity measure;

computing, for each of said one or more rating entities, a rating score for the ratee entity based upon the response scores and the qualification measure of the rating entity; and

computing an overall rating score of the ratee entity based upon the computed rating scores of said one or more rating entities.

Advantageously, embodiments of the invention provide for a nuanced, or multidimensional, rating system in which, for example, multiple characteristics of a ratee entity can be assessed, in accordance with the plurality of questions. Furthermore, embodiments of the invention provide for entities within the network to be qualified in their capacity as raters. This qualification can itself combine a number of factors, including capability, bias, and familiarity with each ratee.

For example, in some embodiments the plurality of questions address a plurality of characteristics of the ratee entity as judged from the perspective of each rating entity. In some embodiments, the characteristics are selected from a group comprising: competency; ethics; reliability; motivation; leadership; resilience; collaboration; receptiveness; and recommendability.

As will be appreciated, positive attributes in relation to the abovementioned characteristics are generally desirable in a candidate for an employment role. Accordingly, such embodiments are particularly applicable for rating and ranking respective candidates within a professional network.

In some embodiments, the plurality of questions comprise one or more questions relating to familiarity of each rating entity with the ratee entity. The response score corresponding with the one or more questions relating to familiarity may be used to compute the familiarity measure.

According to embodiments of the invention, computing an overall rating score comprises calculating an average of the rating scores of each of said one or more rating entities.

In some embodiments computing a rating score of the ratee entity corresponding with a rating entity comprises calculating a weighted sum of the response scores of the rating entity, wherein a weighting value applied to each response score is based upon the qualification measure of the rating entity. In particular, the qualification measure may comprise a product of two or more of the capability measure, the bias measure and the familiarity measure. More particularly, the weighted sum may comprise a sum of a product of the qualification measure and the response scores of the rating entity.

Advantageously, in some embodiments the weighting value applied to each response score is further based upon a question weighting associated with a corresponding one of the plurality of questions. A benefit of such embodiments is that ratings of ratee entities may be adapted to particular requirements, such that responses to all of the questions are not accorded equal weight. For example, a prospective employer may be seeking candidates within a professional networking platform with particular strengths in, say, leadership, agility and sociability, and may therefore wish to apply a higher weighting to these characteristics. Embodiments of the invention are able to meet this need.

In some embodiments, the qualification measure comprises a plurality of qualification measures, each one of said qualification measures corresponding with one of the plurality of characteristics of the ratee entity. Advantageously, this enables a further level of differentiation between rating entities, whereby the competency of a rating entity to provide responses may differ between different ones of the plurality of questions.

In some embodiments, a specific weighting value may be applied to a contribution made to an overall rating based upon one or both of a corresponding rating entity and a corresponding one of the plurality of questions. Advantageously, such embodiments are able to account for differences not only in the relative importance of different questions, but also in the relative skills and qualifications of different rating entities. For example, a rating entity with strong leadership skills could be assigned a higher weight in relation to assessment of leadership. Matrices of weighting values may be developed to account for all combinations of rating entities and questions. Known parameter fitting algorithms may be employed to adapt the values of elements within such matrices to known and/or validated human resources data.

The capability measure of a rating entity may be based upon a previously computed overall rating score of the rating entity. More particularly, the capability measure of the rating entity may be based upon the previously computed rating score of the rating entity relative to previously computed overall rating scores of all of the rating entities. Thus, the responses of rating entities that are themselves more highly rated amongst all of the rating entities of a particular ratee may be accorded a greater weight.

The bias measure of a rating entity may be based upon a plurality of bias measures obtained by comparing response scores provided by the rating entity in relation to each one of a plurality of previously rated ratee entities with response scores provided by other rating entities in relation to the plurality of previously rated ratee entities. Advantageously, a rating entity may therefore be identified as having a bias, for example greater harshness or greater leniency, by comparison with other rating entities that have provided responses in relation to one or more common ratees.

In particular embodiments, the bias measure comprises an average of a set of ratios of response scores provided by the rating entity in relation to each one of the plurality of previously rated ratee entities to an average of corresponding response scores provided by the rating entity and the other rating entities in relation to said one of the plurality of previously rated ratee entities.

In embodiments, the method further comprises computing a confidence measure associated with the overall rating score. The confidence measure may be based upon a number of rating entities that have provided responses in relation to the ratee entity. As will be appreciated, a ratee entity that has been assessed by a larger number of rating entities may have a more reliable overall rating score.

Additionally, or alternatively, the confidence measure may be based upon a confidence measure of one or more of the rating entities. Advantageously, this approach enables a degree of confidence in rating scores used to compute the qualification measures of the rating entities to be taken into account in determining overall confidence in a rating computed for the ratee entity.

Additionally, or alternatively, the confidence measure may be based upon the familiarity measures of the rating entities that have provided responses in relation to the ratee entity. Generally, it may be expected that ratings provided by rating entities that have greater familiarity with the ratee entity are likely to be more reliable.

Additionally, or alternatively, the confidence measure may be based upon one or more relationship categories defining a relationship between a rating entity and the ratee entity. Relationship categories may include such categories as: ‘friend’; ‘junior or professional acquaintance’; ‘peer or customer’; ‘senior or group peer’; and ‘direct supervisor’. However, these examples should not be considered either limiting, or exhaustive. A relationship category may be provided by a ratee entity when nominating a rating entity, and/or by a rating entity when responding to the plurality of question in relation to the ratee entity. Advantageously, the use of relationship categories enables the confidence measure to reflect the fact that some types of relationships between rater and ratee (e.g. a direct supervision relationship) are more likely to result in reliable and objective ratings.

In some embodiments, the confidence measure is computed such that it is based upon both the number of rating entities and their familiarity measures. These may be combined in any proportion. For example, number of ratings and familiarity of rating entities may be combined with equal weight.

According to particular embodiments, the method further comprises re-computing an overall rating score of each entity in the network of entities for which the ratee entity has previously acted as a rating entity. Advantageously, the re-computation, which may be recursive or iterative, updates all rating scores within the network in accordance with changes in overall rating scores of any and all entities within the network. Accordingly, the method may further comprise repeating said re-computing until a stable overall rating score is obtained for all entities in the network of entities. In some embodiments, a single iteration may be performed to re-compute rating scores for rating entities, and two iterations performed to re-compute rating scores for ratee entities.

Further features and benefits of the invention will be apparent from the following description of embodiments, which is provided by way of example only and should not be taken to limit the scope of the invention as it is defined in any of the preceding statements, or in the claims appended hereto.

### BRIEF DESCRIPTION OF THE DRAWINGS

Embodiments of the invention will now be described with reference to the accompanying drawings, in which:

FIG. 1 is a schematic diagram illustrating a system for providing a rating according to an embodiment of the invention;

FIG. 2 is a schematic illustration of rater/ratee entity records in a database embodying the invention;

FIG. 3 is a diagram illustrating rater/ratee relationships in a peer-to-peer network of entities embodying the invention;

FIG. 4 is a flowchart illustrating a method of providing a rating for an entity within a network of the form illustrated in FIG. 3;

FIG. 5 is a flowchart illustrating an event-driven update process embodying the invention;

FIG. 6 is a flowchart illustrating a recursive database update procedure embodying the invention;

FIG. 7 is an illustration of an exemplary questionnaire embodying the invention;

FIG. 8 is a flowchart illustrating further detail of a rating score computation embodying the invention; and

FIG. 9 is a flowchart illustrating further detail of an overall rating computation embodying the invention.

### DETAILED DESCRIPTION OF EMBODIMENTS

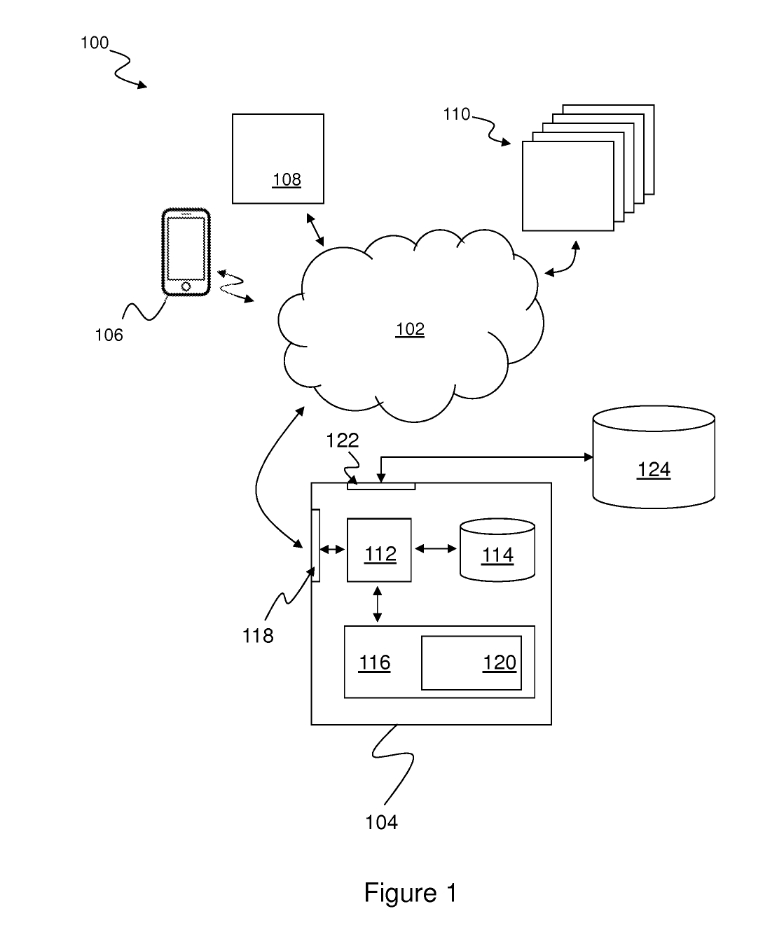

FIG. 1 is a block diagram illustrating schematically an online system 100 embodying the invention. The system 100 employs a wide area communications network 102, typically being the Internet, for messaging between different components of the system each of which generally comprises one or more computing devices.

The system 100 includes a server 104 implementing a peer-to-peer network platform embodying the invention. The server 104 is accessible via the Internet 102 from a variety of suitable client devices, including smart phones 106, personal computers 108, and numerous other alternative and similar connected devices 110.

The platform server 104 may generally comprise one or more computers, and in particular may be implemented using a cluster of computing processors, which may be located at a single data center, or distributed over a number of geographic locations. For simplicity in describing the concepts and operation of embodiments of the invention, reference will be made to a single exemplary server processor 112 of the platform server 104, which is representative of a collection of such processors that may be employed in practical common and scalable embodiments of the invention.

The (or each) processor 112 is interfaced to, or otherwise operably associated with, a non-volatile memory/storage device 114. The non-volatile storage 114 may be a hard disk drive, and/or may include a solid-state non-volatile memory, such as read only memory (ROM), flash memory, or the like. The processor 112 is also interfaced to volatile storage 116, such as random access memory (RAM) which contains program instructions and transient data relating to the operation of the platform server 104. In a conventional configuration, the storage device 114 may contain operating system programs and data, as well as other executable application software necessary to the intended functions of the platform server 104. The storage device 114 may also contain program instructions which, when executed by the processor 112, enable the platform server 104 to perform operations relating to the implementation of a method of providing a rating for an entity within a network of entities, in accordance with embodiments of the invention. In operation, instructions and data held on the storage device 114 are transferred to volatile memory 116 for execution on demand.

The processor 112 is also operably associated with a network interface 118 in a conventional manner. The network interface 118 facilitates access to one or more data communications networks, such as the Internet 102, employed for communication between the platform server 104, client devices 106, 108, 110, as well as any other Internet-enabled services that may be employed by the server 104 in the course of its operations.

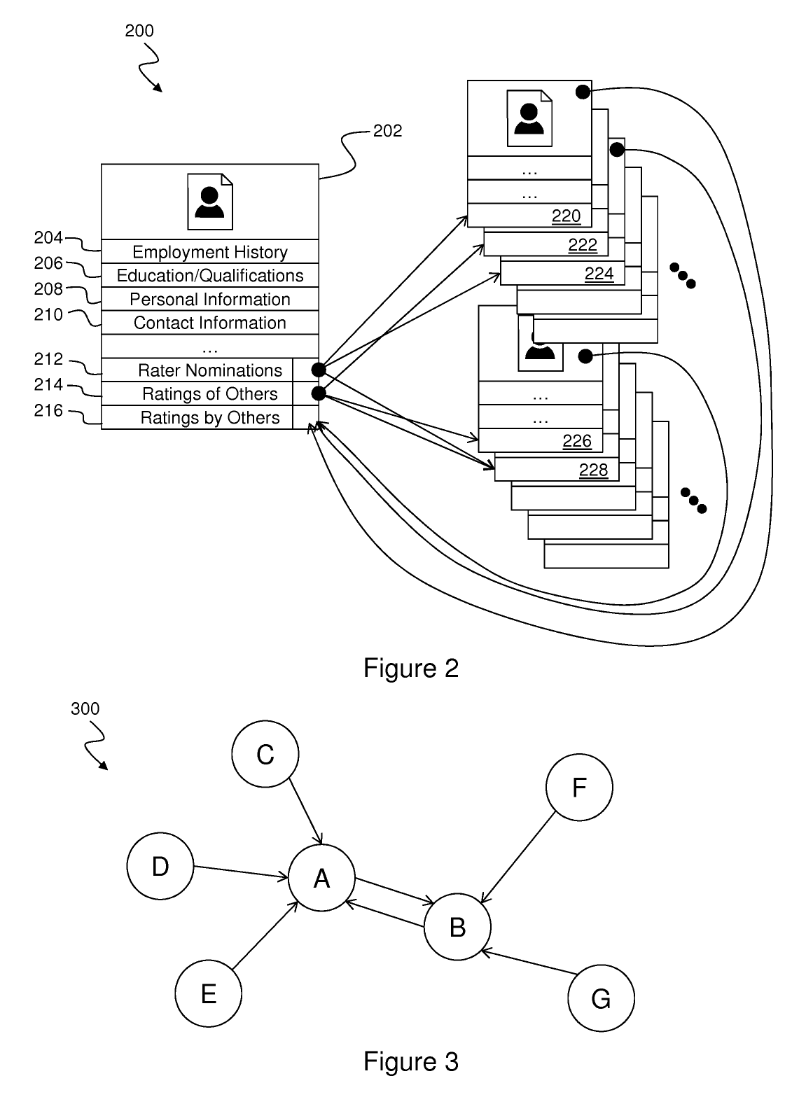

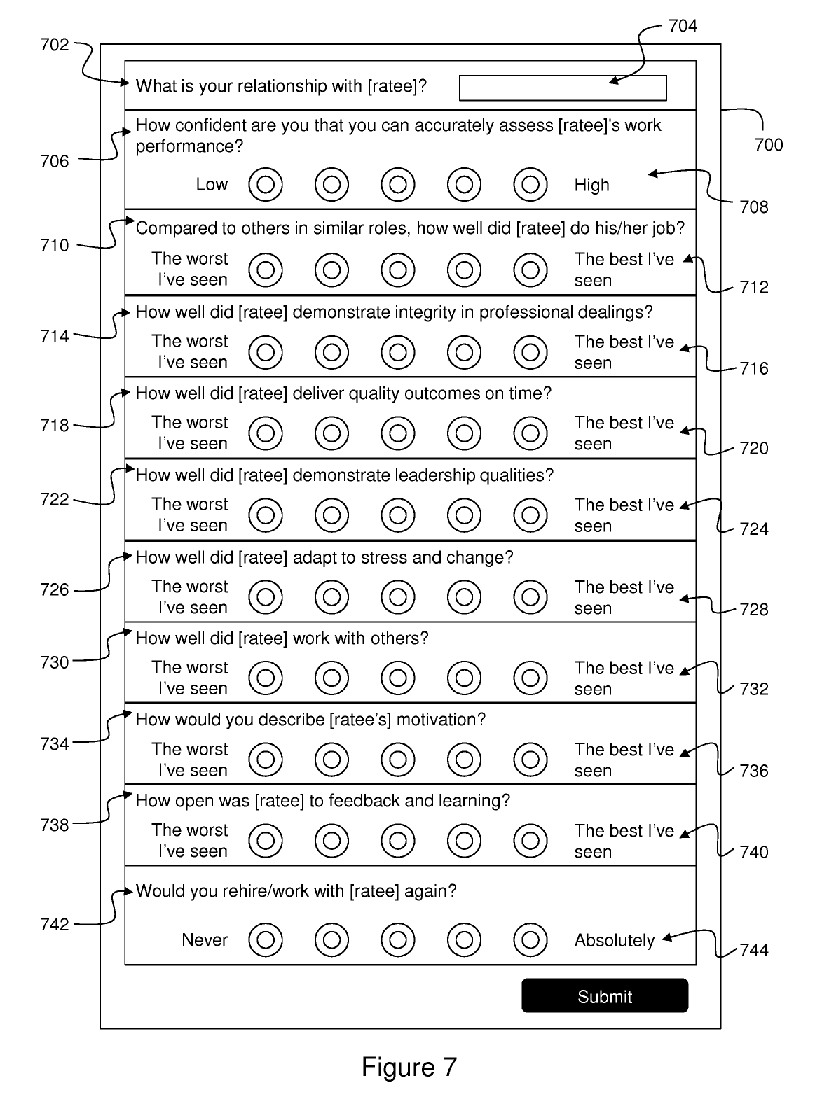

In use, the volatile storage 116 includes a corresponding body 120 of program instructions configured to perform processing and operations embodying features of the present invention, and comprising various steps in the processes described below with reference to the flowcharts, data structures, and information illustrated in FIGS. 2 to 9, and/or as further illustrated in the following examples, and including computations such as those set out in the Appendix. Furthermore, in the presently described embodiment, the program instructions 120 include instructions implementing communications with the client devices 106, 108, 110. This may include instructions embodying a web server application. Data stored in the non-volatile 114 and volatile 116 storage may thus include web-based code for presentation and/or execution on client devices (e.g. HTML or JavaScript code) facilitating a web-based interface to the peer-to-peer network platform 104. The web-based interface may, for example, enable browsing and interaction with entities within the peer-to-peer network (i.e. other users of the system), participation in online discussions, receipt and transmission of web-based messages, and the generation of requests for feedback and ratings, and for providing such feedback or ratings, for example via a questionnaire as illustrated in FIG. 7.

The processor 112 is also operably associated with a further interface 122, such as a Storage Area Network (SAN) interface providing access to large-scale storage facilities 124. The storage facilities 124 may be collocated with the platform server 104, or may form part of a remote and/or distributed database accessible via the Internet 102, or other communications networks. The storage interface 122 may be a separate physical interface of the platform server 104, or may be a virtual interface implemented via the physical network interface 118. These and other mechanisms for providing and accessing large-scale storage 124 will be apparent to persons skilled in the relevant arts.

The large-scale storage 124 is used to store, access, update and maintain databases employed by the platform server 104. FIG. 2 is a schematic illustration 200 of rater/ratee entity records that may be stored in one such database embodying the invention. For clarity and specificity of the description, an exemplary embodiment will be disclosed comprising a peer-to-peer professional network, in which individual entities represent users of the platform each of whom may be an employer, employee, work colleague, job seeker, professional networker, and/or any other person interested in participating in a peer-to-peer professional network as provided via the platform 104. As will be appreciated, each individual user of such a platform may, at one time and/or at various times, fulfill more than one of the foregoing professional roles. In particular, for the purposes of the present embodiment of the invention, each member of the peer-to-peer professional network may, from time to time, act as a rating entity (i.e. being a rater or referee of one or more other members of the network), as a ratee entity (i.e. a member receiving ratings or references from other members of the professional network), or as both rater and ratee.

A typical record 202 within the database includes various fields relating to the user entity that may be relevant to their participation in a peer-to-peer professional network. Fields, or groups of fields, within the record 202 comprise, for example: employment history 204; education and/or qualifications 206; personal information 208; and contact information 210. Additionally, in accordance with embodiments of the invention, further fields are provided comprising references to and/or from other records within the database. These fields may encompass rater nominations 212, records of ratings provided by the user to other members of the network 214, and references to ratings of the user provided by other members of the professional network 216.

By way of example, the illustration 200 indicates that the user associated with the record 202 has nominated users associated with records 220, 224 and 228 to provide ratings of their professional skills and/or competency. Furthermore, the user associated with record 202 has provided ratings of other users associated with the records 222, 226 and 228. The user has received ratings from the users associated with records 220, 224 and 226. As will be appreciated, information regarding all nominations, ratings provided in response to questions and questionnaires, and ratings received, may all be maintained within appropriate fields of records stored within the database and held within the large-scale storage 124.

Turning now to FIG. 3, there is shown a diagram 300 illustrating rater-ratee relationships in a peer-to-peer network of entities embodying the invention. In this minimal example, provided for illustrative purposes, seven rater/ratee entities are shown indicated by upper-case letters. Entities A and B are subject to ratings from other entities, and also from each other. That is, both entities A and B act as rater entity and ratee entity within the exemplary network 300. Additionally, entities C, D and E are rating entities of A as ratee entity, while entities F and G are rating entities of B as ratee entity.

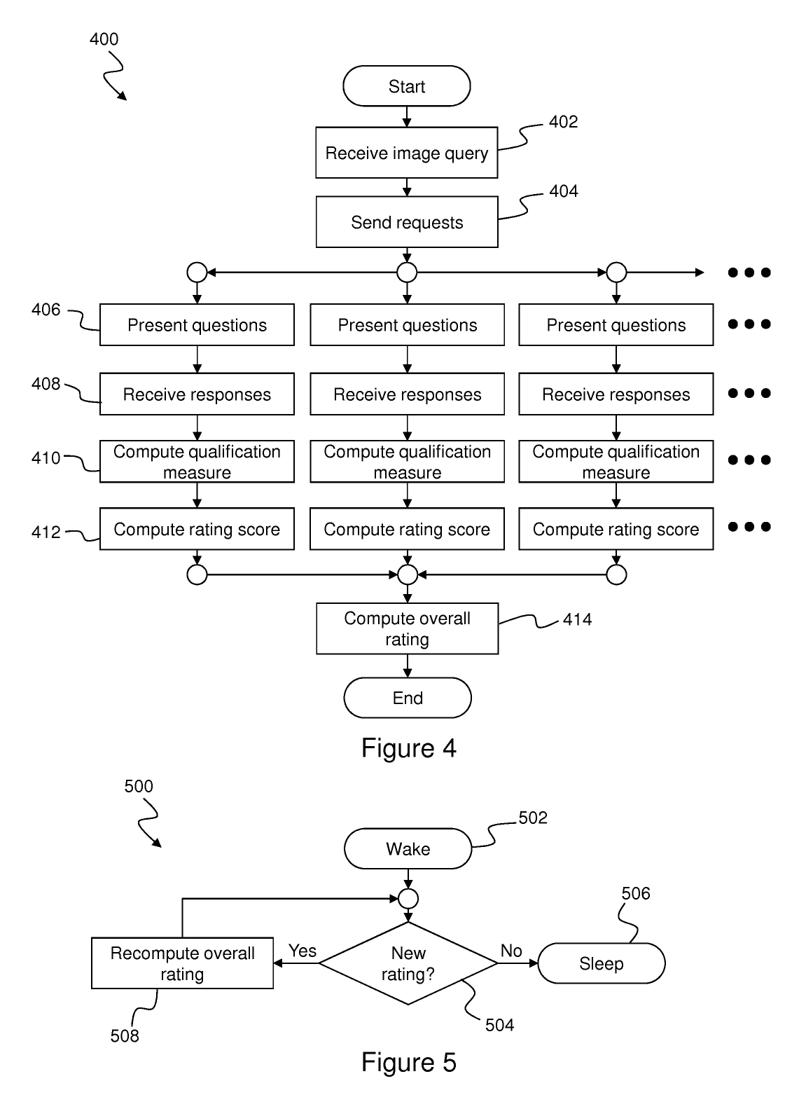

In general terms, ratings within the exemplary system comprise a number of scores provided according to a rating scale. These may be response scores, provided in response to a questionnaire, such as will be described below with reference to FIG. 7. The rating scale may be an integer-valued or real-valued numerical scale, defined over a range having minimum and maximum values. For example, and without limitation, a suitable rating scale may be an integer scale varying between response values of one and five. The rating scale may be presented as a Likert scale (i.e. selectable buttons), as a slider, or by any other convenient and suitable means. Response scores are combined, in accordance with embodiments of the invention, in order to provide rating scores of each rating entity in relation to a ratee entity. These rating scores may further be combined to provide an overall rating score. General principles of suitable calculations embodying the invention will be described with reference to FIGS. 4 to 9, following which a number of examples are provided, with details of exemplary calculation methods being set out in the Appendix.

FIG. 4 shows a flowchart 400 illustrating a method of providing a rating for an entity within a network of entities, according to an embodiment of the invention. In the exemplary case of a peer-to-peer professional network, individuals elect to receive ratings (i.e. references) from other members of the network who are known to them, and who may therefore have sufficient familiarity with their relevant skills, experiences and/or characteristics. Accordingly, at step 402 the system receives one or more nominations of selected rating entities from a ratee entity. At step 404 requests are communicated to the nominated rating entities, so that they become aware of their nomination. These requests may comprise messages communicated via the network platform, messages sent via email, messages sent by other means (e.g. SMS), or any combination of messaging technologies.

In the event that a nominated rating entity is not a member of the peer-to-peer professional network, the ratee entity may be prompted to provide suitable contact details, such as an email address, for the rating entity. The system can then notify the nominated rating entity using this contact information, and provide a hyperlink or other reference to enable to rating entity to access the system to provide a rating for the ratee entity. The rating entity may further be prompted or encouraged to create an account on the peer-to-peer professional network.

If a nominated rating entity, e.g. a user of the networking platform, accepts the nomination, they are then able to proceed through the process of providing a rating. This may comprise accessing the platform server 104, for example using a conventional web browser, a mobile app, or any other convenient means. The user acting as a rating entity is then presented with a questionnaire, at step 406. Upon completion of the questionnaire, responses are submitted, or transmitted, and at step 408 are received by the system.

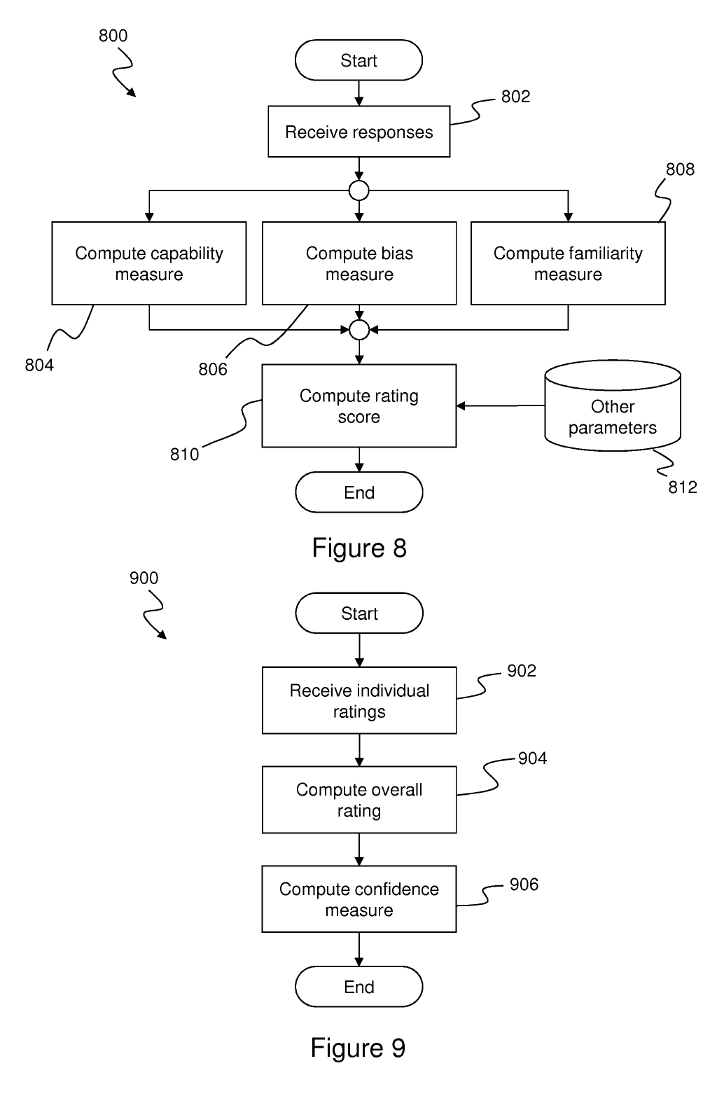

At step 410 the system then computes a qualification measure for the rating entity, further details of which are described below with reference to FIG. 8. At step 412 a rating score is computed, based upon response scores received at 408, and upon the qualification measure computed at 410.

As indicated by the parallel paths in the flowchart 400, rating scores from a plurality of nominated rating entities may be received, and then combined to compute a total overall rating of the ratee entity at step 414.

FIG. 5 shows a further flowchart 500 illustrating an event-driven update process embodying the invention. The implementation of an event-driven process may be useful, because in practice responses from different rating entities, as received at step 408, will generally be provided at different times, and possibly over an extended period. Accordingly, upon receipt of a new set of response scores from a rating entity, it may be necessary to recompute the overall rating of the ratee entity.

Accordingly, at step 502 the process wakes, and at step 504 checks to determine whether there are unprocessed new ratings received from rating entities. If not, then the process returns to sleep at step 506. Otherwise, the corresponding overall rating is recomputed at step 508, and control returns to decision step 504, to determine whether there are further new rating results requiring processing. Embodiments of the invention may envisage that a single rating entity may provide more than one rating to a particular ratee over time. Thus a new rating retrieved by the process 500 may supersede a previous rating provided by the same rating entity to a corresponding ratee entity. Embodiments of the invention may retain only the most recent rating provided by a rating entity to a ratee entity, or may retain a history of all ratings provided.

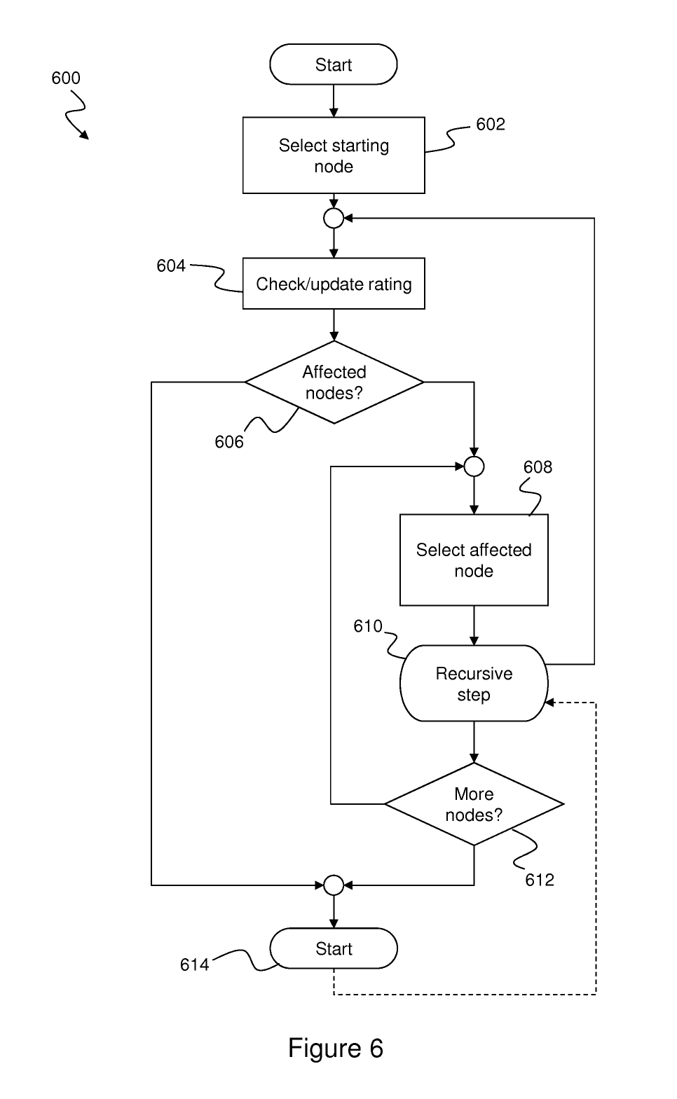

FIG. 6 is a flowchart 600 illustrating a recursive database update procedure embodying the invention. A process such as that illustrated in the flowchart 600, or an alternative iterative process, or other equivalent method, is required in embodiments of the invention because contributions made by individual rating entities to overall ratings assigned to ratee entities may themselves depend, in turn, upon ratings provided to the rating entity in its alternative role as a ratee entity. That is, embodiments of the invention incorporate the concept of ‘rating the rater’, in order to more-completely account for differences in skills, capabilities, familiarity, and other factors that influence the relative significance and reliability of ratings provided by a rating entity to a ratee entity. Accordingly, any update to the ratings provided to any entity within the peer-to-peer network has potential flow-on effects to other entities for which the updated entity has acted as a rating entity.

At step 602 a starting node (i.e. entity record) within the peer-to-peer network is selected. This can be any node with outgoing connections (i.e. an entity with a role as a rating entity), and will typically be a node that has recently been updated (e.g. as a result of receiving a new rating). The change in rating is noted and/or updated at step 604. At step 606 a check is conducted to determine whether there are any affected nodes, i.e. one or more entities for which the current entity has provided a rating. If one or more affected nodes exist, a selection is made at step 608 of one affected note. In a recursive step 610, a method- or function-call is made and control returns to step 604, this time to update the rating of the selected affected node. This, in turn, may result in further affected nodes being identified (at step 606), and further recursive method calls.

Upon return from the recursive step 610, a check is performed at 612 to determine whether there are more affected nodes requiring processing. If so, control returns to step 608 to select the next affected node. If no, then control passes to the return step 614 of the method. As will be appreciated, this may result in a return from a recursive step (i.e. to step 610), or a final return from the process 600.

The recursive process 600 will update all nodes accessible via a rater-ratee relationship chain connected to the starting node selected at step 602. The resulting directed graph may contain closed cycles, for example as with the entities A and B in the illustration 300 of FIG. 3, each of which acts as a rating entity for the other. Such cycles are readily identified, for example by tagging entities as they are visited by the recursive process 600, and can therefore be handled appropriately. As a practical matter, the algorithms and calculations employed by embodiments of the invention must be stable in the presence of such cycles, and in particular there should be a steady state to which ratings in a cycle will converge. Although not shown in the simplified flowchart 600, handling of cycles, and checks for convergence, or other mechanisms to terminate processing of cyclic paths, should be included. In some embodiments, for example, the recursive update process 600 may simply terminate at a predetermined maximum depth of recursion. This need not be particularly deep, and indeed two or three levels of recursion may be sufficient, considering that the effect of a change in rating of a rating entity is effectively ‘diluted’ or attenuated as it propagates through stages of ratee/rating entities.

In general, the directed graph representing rater-ratee relationships within the peer-to-peer network of entities may not be fully connected, i.e. it may comprise a number of sub-graphs of connected groups of entities. Accordingly, it may be necessary to execute the recursive process 600 multiple times, selecting a different starting node at step 602 on each occasion, until all sub-graphs of the network have been fully traversed, and all updated ratings propagated.

In some embodiments a simple iterative update process may be employed across the entire network of entities. In a first iteration, each node is accessed in turn (irrespective of actual connections in the directed graph), and one or more components of the qualification measure updated, where necessary, based upon new or updated ratings of the corresponding entity. In at least one further iteration, each node is again accessed in turn, and the associated rating score of the corresponding is updated, where necessary, in response to changes in the qualification measures of one or more associated rating entities. Multiple such further iterations may be performed, in order to propagate rating changes further within the network however, as has already been noted, such changes are rapidly attenuated in repeated passes.

It will be appreciated that this iterative process is simple to implement, but may be inefficient due to the requirement to visit every node in the network regardless of whether or not any update is necessary. However, for small- to moderate-sized networks, or implementations in which full re-computation is performed relatively infrequently, the cost of this inefficiency may be acceptable, in exchange for simplicity. In very large networks, and/or where very frequent re-computation is required, the additional complexity of implementing the efficient recursive algorithm as shown in the flow chart 600 may be justified.

FIG. 7 illustrates an exemplary questionnaire 700, such as may be presented to a user providing a rating following acceptance of a nomination from a ratee. The exemplary questionnaire 700 includes nine questions. The first two questions relate to familiarity of the rater with the ratee. A first question 702 requests the rater to identify their relationship to the ratee, and may accept a free-text response 704, and/or may offer a list of options. It may be possible to associate a response score with this question, for example if multiple choices are provided that can be categorized from ‘most familiar’ to ‘least familiar’. Alternatively, or additionally, this information may be used by an interested party, such as prospective employer of the ratee, by way of context.

The second familiarity question 706 requests a subjective assessment of the rater's ability to provide a rating for the ratee. This question expects a response in accordance with a rating scale 708.

The remaining nine questions in the questionnaire 700 relate to relevant professional characteristics of the ratee. These are:
a competency question 710, requiring a response according to a rating scale 712;
an ethics question 714, requiring a response according to a rating scale 716;
an reliability question 718, requiring a response according to a rating scale 720;
a leadership question 722, requiring a response according to a rating scale 724;
agility resilience question 726, requiring a response according to a rating scale 728;
a collaboration question 730, requiring a response according to a rating scale 732;
a motivation question 734, requiring a response according to a rating scale 736;
a receptiveness question 738, requiring a response according to a rating scale 740; and
a recommendability question 742, requiring a response according to a rating scale 744.

FIG. 8 shows a flowchart 800 illustrating further detail of a rating score computation embodying the invention. At step 802, responses are received, i.e. the response scores provided by a rating entity via the questionnaire 700. A number of measures may then be calculated in relation to the rating entity. It should be noted that any one or more of these measures may be employed in particular embodiments of the invention, in order to arrive at a qualification measure of the rating entity.

At step 804 a capability measure is computed. The capability measure relates to the general skills and competency of the rating entity to provide a ratee with a rating, and is dependent upon the rating entity's own rating scores. According to embodiments of the invention, the capability measure is based upon a previously computed overall rating score of the rating entity. More particularly, the capability measure is based upon the previously computed overall rating score of the rating entity relative to previously computed overall rating scores of all of the rating entities presently providing ratings to the particular ratee. In general, a rating entity which itself has a higher rating score will be attributed with a higher capability measure, and its ratings of the ratee entity will be accorded a larger weight. Details of an exemplary calculation procedure for the capability measure are set out in the Appendix, with particular reference to Equations (5) and (9).

At step 806 a bias measure is computed. The bias measure is designed to account for the fact that different rating entities will be generally inclined to be more harsh, or more lenient, when providing ratings, in accordance with their own perception and personalities. The aim of a bias measure is therefore to normalize ratings provided by multiple rating entities, so as to reduce harshness or leniency bias.

According to embodiments of the invention, the bias measure is based upon a plurality of bias measures obtained by comparing response scores provided by the rating entity in relation to each one of a plurality of previously rated ratee entities against response scores provided by other rating entities in relation to the plurality of previously rated ratee entities. The general concept is to look at all ratings provided by a particular rating entity across multiple ratee entities, to compare these with ratings provided by other rating entities of one or more of the same ratees, and thus to asses whether, on average, the current rating entity tends to be a harsher or more-lenient judge. The bias measure is then computed to account for this bias.

More particularly, the bias measure comprises an average of a set of ratios of response scores provided by the rating entity in relation to each one of the plurality of previously rated ratee entities to an average of corresponding response scores provided by the rating entity and the other rating entities in relation to each one of the plurality of previously rated ratee entities. A detailed method of obtaining a suitable bias measure is set out in the Appendix, with particular reference to Equations (6) and (10).

At step 808 a familiarity measure is computed. The familiarity measure may be derived directly from a quantitative familiarity response score, such as the response score 708 provided in reply to the familiarity question 706. It may be, for example, a simple ratio of the actual response score to the maximum response score. Details of the calculation and use of such a familiarity measure are set out in the Appendix, with particular reference to Equation (7).

Additional measures may also be computed and incorporated into an overall rating score, and the examples of capability, bias and/or familiarity measures should not be regarded as exhaustive. For example, another measure that may be computed in some embodiments of the invention is a relationship measure, e.g. based upon a response to the relationship question 702. Such a relationship measure could be used to reduce the contribution made by rating entities whose relationship to the ratee entity is associated with a lower expectation of relevance and reliability. For example, a rating entity related to the ratee entity as a friend would typically be accorded less significance in rating a job candidate than a rating entity related as a former or current direct supervisor.

At step 810 an overall rating score is computed, using the response scores received at 802, in combination with one or more of the elements 804, 806, 808 of the qualification measure. Other parameters 812 may also be employed in completing the overall rating score. By way of example, a rating score may be required for a particular prospective employer, which may value one or more of the characteristics (i.e. competency, ethics, accountability, leadership, agility, sociability and recommendability) more highly than others. Accordingly, a rating score that applies higher weightings to the desirable characteristics may be preferable for such a prospective employer. Weighting parameters of this type may be drawn from information held in a database associated with the interested party, i.e. the prospective employer. These, and other, additional parameters may be employed in computing a rating score at step 810. Examples of such parameters in particular embodiments will be apparent from the more-detailed calculation methods set out in the Appendix, with particular reference to Equations (11) to (17).

FIG. 9 shows a flowchart 900 illustrating further detail of an overall rating computation embodying the invention. This procedure 900 may be employed, for example, in the computation step 414 of the process 400, and/or in the re-computation step 508 of the process 500.

At step 902, individual ratings of rating entities, i.e. as computed at step 810 of process 800, are received. At step 904 an overall rating is computed. Exemplary methods of computing an overall rating are illustrated in the following examples, and detailed calculation methods set out in the Appendix, with particular reference to Equations (4) and (8).

At step 906, a confidence measure may be computed. While computation of a confidence measure is optional, it may be extremely useful in assessing the reliability of the overall rating computed at step 904.

According to embodiments of the invention the confidence measure may be based upon a number of rating entities that have provided responses in relation to the ratee entity. It is reasonable to suppose, for example, that the larger the number of ratings or references provided for a particular ratee, the more reliable the overall rating is likely to be. Alternatively, or additionally, the confidence measure may be computed based upon familiarity measures of the rating entities that have provided responses in relation to the ratee. Again, it seems reasonable to presume that raters who are more familiar with the ratee will provide more reliable ratings/references. A confidence measure may be computed by combining multiple indications of confidence, for example by combining a component based upon a number of rating entities that have provided responses, and a component based upon the familiarity measures associated with those rating entities. These different components may be combined in any effective proportion, based on experience. In the simplest case, all measures making up the confidence measure may be combined with equal weighting, and an example of details of such a calculation is set out in the Appendix, with particular reference to Equations (18) to (23).

A number of examples will now be provided, in order to illustrate the principles of the invention as described above. As will be appreciated, these examples are not intended to limit the scope of the invention, but rather to assist in its proper understanding.

### EXAMPLE 1

In a first example, a dataset of 248 peer-to-peer ratings was collected for 98 subjects and 49 judges. Within this set most of the judges were also subjects. Scores on an integer scale of 1-5 were obtained from judges for an exemplary set of seven criteria: competency; ethics; accountability; leadership; agility; sociability; and recommendability. A familiarity score was also obtained in each case.

A subset of 52 out of the 98 subjects was also rated by a small group of trusted peers who knew the competencies of these subjects. These trusted peer ratings formed a ‘truth’ dataset against which ratings generated according to embodiments of the invention could be compared.

Four different ratings were computed for each subject as follows (see the Appendix for further details of the algorithms):
R⁰ₛ, i.e. a ‘raw average’ rating based on judges' assessments only;
R¹ₛ[F=0, L=0], i.e. a first order correction using judges' weightings (i.e. capability measures) embodying the invention, but excluding leniency and familiarity adjustments (i.e. bias and familiarity measures);
R¹ₛ[F=0, L=1], i.e. a first order correction using judges' weightings and leniency scores (i.e. capability and bias measures) embodying the invention, but excluding familiarity measure adjustment; and
R²ₛ[F=0, L=0], i.e. a second order correction using judges' weightings (i.e. capability measures) embodying the invention, but excluding leniency and familiarity adjustments.

A comparison of the rankings generated using the above rating methods with the rankings of the truth dataset are shown in the table below. The values in the table are Kendall rank correlation coefficients (also known as Kendall Tau, or simply tau values), which measure of the degree of correlation between two rankings, where 1 (or 100%) indicates an identical ranking, 0 (0%) represents a random comparison and −1 (−100%) indicates a reversed ranking. The columns in the table reflect different thresholds for selection of ratings from the dataset, depending upon the minimum number of ratings nₛ received by each subject (as a ratee) and the minimum number of ratings nⱼ received by each judge (as a rater).

| | nⱼ ≧ 0 | nⱼ ≧ 0 | nⱼ ≧ 0 | nⱼ ≧ 2 | nⱼ ≧ 2 | nⱼ ≧ 2 |
|---|---|---|---|---|---|---|
| | nₛ ≧ 0 | nₛ ≧ 2 | nₛ ≧ 3 | nₛ ≧ 0 | nₛ ≧ 2 | nₛ ≧ 3 |
| R⁰ₛ | 0.551 | 0.603 | 0.706 | | | |
| R¹ₛ[0, 0] | 0.563 | 0.624 | 0.740 | 0.492 | 0.524 | 0.61 |
| R¹ₛ[0, 1] | 0.543 | 0.608 | 0.714 | 0.479 | 0.503 | 0.602 |
| R²ₛ[0, 0] | 0.565 | 0.619 | 0.732 | 0.461 | 0.460 | 0.584 |

It will be noted that, in this example, R¹ₛ[0, 0] and R²ₛ[0, 0] exhibit the best match to the truth dataset, when nₛ≧3. R¹ₛ[0, 0] exhibits a 19% improved match with the truth dataset, of 74% as compared with R⁰ₛ=55%).

### EXAMPLE 2

In a second example, the same dataset of 248 peer-to-peer ratings was employed. In this case, a familiarity measure embodying the invention was used, with an exponent of ⅓, to compute R⁰ₛ[F=⅓, L=0]. The calculation was performed over all subjects for which the familiarity measure was not equal to unity, i.e. where the judge(s) did not consider themselves ‘ideally’ placed to assess the ratee's performance, these being the cases in which lack of familiarity may affect the overall rating. These results were compared with the corresponding raw average rating, R⁰ₛ, and are shown in the following table.

| | nⱼ ≧ 0 | nⱼ ≧ 0 |
|---|---|---|
| | nₛ ≧ 0 | nₛ ≧ 3 |
| R⁰ₛ | 0.551 | 0.706 |
| R⁰ₛ[⅓, 0] | 0.563 | 0.749 |

This example demonstrates the improvement in rank correlation that is achieved when a familiarity measure is included in the calculations, particularly for subjects having received more than three ratings.

### EXAMPLE 3

In a third example, the same dataset of 248 peer-to-peer ratings was employed. In this case, a bias measure embodying the invention was used, with an exponent of ⅕, to compute R⁰ₛ[F=0, L=⅕]. The calculation was performed over all subjects for which the bias measure was not equal to unity, i.e. where the judge(s) showed an objective bias relative to the average, these being the cases in which leniency of harshness of particular judges may affect the overall rating of a subject. These results were compared with the corresponding first-order corrected rating R¹ₛ[F=0, L=0], and are shown in the following table.

| | nⱼ ≧ 0 |
|---|---|
| | nₛ ≧ 3 |
| R¹ₛ[0, 0] | 0.610 |
| R¹ₛ[0, ⅕] | 0.620 |

This example demonstrates the improvement in rank correlation that can be achieved when a bias measure is included in the calculations.

### Variations

While particular embodiments have been described, by way of example only, a person skilled in the relevant arts will appreciate that a number of variations are possible, within the scope of the present invention.

For example, the particular questions and rating scales described herein, and exemplified in FIG. 7, are not exclusive or exhaustive. Alternative and/or additional questions may be provided to meet differing or changing needs, improved understanding of the most important characteristics for producing reliable and consistent ratings, or to meet the requirements of different communities and peer networks. For example, in a network of entities comprising a marketplace for goods and services, a set of questions might address such characteristics as efficiency of service, friendliness, responsiveness, level of customer assistance, and value for money.

It is also envisaged that optional questions may be provided, in addition to the core set of questions used to derive consistent overall ratings across the entire network of entities. For example, each member of a professional network may be provided with a facility to create or select specific questions relating to their skills, experience and competency in specialist areas. Such question might relate, for example, to a lawyer's specific areas of practice, such as family law or commercial law, or to a teacher's specialist subjects, such as literature, mathematics or physics. Additional questions of this kind may be presented to the rating entities, and responses scored and weighted as for the core set of common questions. These additional ratings may be incorporated into a single overall rating and/or they may be presented as a set of separate ratings relating to each specialist question or area of expertise.

In some embodiments of the invention, a member of a professional network platform may be enabled to develop a permanent, or long-term, record of skills and experience, education, qualifications, and employment history, alongside a corresponding history of ratings and references. The platform will thereby have an enhanced capability to match members with employment opportunities, not only by comparing skills, qualifications and experience with job requirements, but also by ranking candidates based upon the ratings they have accumulated from nominated rating entities, i.e. their professional contacts, including current and/or past employers, managers and colleagues

Other variations and enhancements are also possible, many of which will be apparent to persons skilled in the relevant arts based upon the foregoing disclosure of the invention and embodiments. Accordingly, these exemplary embodiments should not be regarded as limiting, but rather the invention is as defined in the claims appended hereto.

### Appendix: Exemplary Methods of Calculation

In this Appendix, there is set out an exemplary set of algorithms or methods of calculation embodying the invention. This is provided so as to better illustrate an implementation of the invention, however it should not be regarded as exhaustive or limiting. As will be appreciated by persons skilled in the art, many of the methods or algorithms described herein involve a selection of parameters and/or particular computations in order to serve the requirements of a particular embodiment of the invention. This does not exclude the use of additional or alternative methods, such as would be apparent to the skilled person.

Inputs to the methods are responses to K questions relating to relevant professional characteristics of a ratee (e.g., as shown in FIG. 7, K=9) plus a response to a familiarity question, e.g. question 706 in FIG. 7. These inputs are represented as follows:

Rₛⱼ(k) [symbol] rating of subject/ratee s by judge/rater j for question/dimension k
Fₛⱼ [symbol] non-zero familiarity of s to j as assessed by j

An average ‘zeroth-order’ rating of ratee s for question k across a total number of judges/raters J providing such ratings may be computed as:

$${R}_{s}^{0} ( k ) = \frac{1}{J} {\sum }_{j} {R}_{sj} ( k ) \qquad ( 1 )$$

An average ‘zeroth-order’ rating of ratee s across all questions for a single judge j may be computed as:

$${R}_{sj}^{0} = \frac{1}{K} {\sum }_{k} {R}_{sj} ( k ) \qquad ( 2 )$$

A ‘zeroth-order’ total rating, across all judges and questions may thus be computed as:

$${R}_{s}^{0} = \frac{1}{K} {\sum }_{k} {R}_{s}^{0} ( k ) = \frac{1}{J} {\sum }_{j} {R}_{sj}^{0} \qquad ( 3 )$$

A first-order, or ‘corrected’ rating for subject s, embodying the invention, may then be computed from:

$${R}_{s}^{1} = {\sum }_{j} ( {W}_{j}^{0} \cdot {L}_{j}^{0} \cdot {F}_{sj}^{′} \cdot {R}_{sj}^{0} ) \qquad ( 4 )$$

In Equation (4), the parameter W⁰ⱼ is a capability measure for judge j, based upon ratings provided for that judge as a ratee by a set of size J′ of other judges {j′}, which may be computed as:

$${W}_{j}^{0} = {[ \frac{1}{{J}^{′}} {\sum }_{{j}^{′}} {R}_{{jj}^{′}}^{0} ]}^{c} \qquad ( 5 )$$

In Equation (5), the parameter c is an exponent that can optionally be used to ‘tune’ the effect of the capability measure W⁰ⱼ. Setting c=0 effectively ‘disables’ this component, while setting c=1 enables a linear capability contribution. While these are anticipated to be the most common options, other values of c may be used in some embodiments. For example, an optimization procedure may be employed to identify a value of c which results in a maximum ranking correlation between ratings produced according to an embodiment of the invention, and ratings in a verified ‘truth’ dataset (see, e.g., Examples 1-3 above).

In Equation (4), the parameter L⁰ⱼ is a bias measure for judge j, expressed as a ‘leniency’. Conversely, bias may be expressed in terms of ‘harshness’, in which case the bias measure may be represented as H⁰ⱼ. These measures may be computed as:

$${H}_{j}^{0} = {( {L}_{j}^{0} )}^{- 1} = {[ \frac{\frac{1}{Q} {\sum }_{q} {R}_{qj}^{0}}{\frac{1}{{J}^{″} Q} {\sum }_{{j}^{″}} {\sum }_{q} {R}_{{qj}^{″}}^{0}} ]}^{a} \qquad ( 6 )$$

In Equation (6), the set of size J″ of judges {j″} represents those raters who have provided ratings for the set of Q subjects {q} for which the current judge j has provided ratings, such that the bias parameter reflects the tendency of the current judge to rate subjects above or below the average. The parameter a is an optional exponent, similar to c in Equation (5), whereby setting a=0 effectively ‘disables’ the bias component, setting a=1 enables a linear bias contribution, and other values may be employed in order to ‘tune’ the effect of the bias measure on the overall corrected rating.

Finally, in Equation (4), the parameter F′ₛⱼ is a familiarity measure, which may be computed as:

$${F}_{sj}^{′} = {[ \frac{{F}_{sj}}{{F}_{max}} ]}^{b} \qquad ( 7 )$$

In Equation (7), Fₘₐₓ is the maximum value of familiarity Fₛⱼ, e.g. for an integer Likert scale of 1 . . . 5, Fₘₐₓ=5. The parameter b is an optional exponent, similar to c in Equation (5), whereby setting b=0 effectively ‘disables’ the familiarity component, setting b=1 enables a linear familiarity contribution, and other values may be employed in order to ‘tune’ the effect of the familiarity measure on the overall corrected rating.

Taken together, the three components of capability W⁰ⱼ, bias L⁰ⱼ (or H⁰ⱼ) and familiarity F′ₛⱼ comprise a qualification measure for judge j in relation to subject s.

It is further possible to define a set of higher-order corrected rates, wherein the z^{th}-order rating (for z>1) is computed as:

$${R}_{s}^{z} = {\sum }_{j} ( {W}_{j}^{z - 1} \cdot {L}_{j}^{z - 1} \cdot {F}_{sj}^{′} \cdot {R}_{sj}^{z - 1} ) \qquad ( 8 )$$

In Equation (8), the higher-order qualification measure terms are given by:

$$\begin{matrix}{W}_{j}^{n} = {[ \frac{1}{{J}^{′}} {\sum }_{{j}^{′}} {R}_{{jj}^{′}}^{n} ]}^{c} & ( 9 ) \\ {H}_{j}^{n} = {( {L}_{j}^{n} )}^{- 1} = {[ \frac{\frac{1}{Q} {\sum }_{q} {R}_{qj}^{n}}{\frac{1}{{J}^{″} Q} {\sum }_{{j}^{″}} {\sum }_{q} {R}_{{qj}^{″}}^{n}} ]}^{a} & ( 10 )\end{matrix}$$

In some embodiments of the invention it may be desirable to provide for ‘tuneability’ of the contributions made to an overall rating by different judges and different questions. For example, ratings may be required for candidates who have applied for a role in which some characteristics (e.g. leadership, ethics) are more important that others (e.g. collaboration, receptiveness), such that it would be beneficial to attribute different weights to the scores provides by judges in relation to different questions. Additionally, or alternatively, varying weights may be applied based upon each judge's specific competency to assess different characteristics of ratees. For example, a judge with strong leadership skills could be assigned a higher weight in relation to assessment of leadership. It is also possible that strengths in other areas, e.g. ethics, may correlate with a stronger competency to rate, e.g., leadership.

According to some embodiments, tuning may be implemented via a generalization of Equation (4) in which:

$${W}_{j}^{0} \cdot {R}_{sj}^{0} \to \frac{1}{N} Tr ( {I}_{k} {T}_{j} {r}_{sj}^{0} ) \qquad ( 11 )$$

In Equation (11), Iₖ is the rank-K identify matrix, r⁰ₛⱼ is a K-element vector comprising elements Rₛⱼ(k), Tr(.) is the Trace function, N is a normalization value, and Tⱼ is a K×K matrix defined as follows:

$${T}_{j} = ( \begin{matrix}{t}_{11} & {t}_{12} & … & {t}_{1 K} \\ {t}_{21} & {t}_{22} & & \\ ⋮ & & ⋱ & \\ {t}_{K 1} & & & {t}_{KK}\end{matrix} ) ; {t}_{{kk}^{′}} = {w}_{{kk}^{′}} {R}_{j}^{0} ( k ) ; \\ {R}_{j}^{0} ( k ) = \frac{1}{{J}^{′}} {\sum }_{{j}^{′}} {R}_{{jj}^{′}} ( k ) \qquad ( 12 )$$

In Equation (12), R⁰ⱼ(k) is a judge rating in respect of the individual question k, defined analogously to Equations (1) and (5), and w_{kk′} is a tunable weighting value. Equation (11) thus represents a general linear combination of judge and subject ratings, whereby Equation (4) is a special case in which the matrix T is diagonal with all values wₖₖ being equal. Furthermore, the case in which T is diagonal, but with differing values for the coefficients wₖₖ, represents a purely question-based tuning. In embodiments of the invention, a facility may be provided whereby a user, such as a prospective employer requesting rankings of candidates for a specific role, is enabled to adjust question-based weightings directly, e.g. by entering a weighting value, moving a slider, or via any other convenient user interface element.

The weight coefficients w_{kk′} may be determined in any suitable manner. Given a sufficiently large data set, a fitting process could be used to determine coefficients resulting in the closest comparative ranking with a control or ‘truth’ data set and/or upon known human resources performance data. The fitting process may be based upon known methods such as differential evolution, simulated annealing, or any other suitable optimization or fitting algorithms.

The normalization factor N in Equation (11) is computed as:

$$N = J \cdot {\sum }_{m} {\sum }_{n} {t}_{mn} \qquad ( 13 )$$

Alternatively, or additionally, ratings may be tuned according to the following generalization of Equation (2):

$${R}_{s}^{v , 0} = \frac{1}{JK} {\sum }_{j} {\sum }_{k} {v}_{jk} {R}_{sj} ( k ) \qquad ( 14 )$$

In Equation (14), the weight coefficients vⱼₖ may be determined in any suitable manner, such as by fitting to known information as discussed above. In other embodiments, the coefficients vⱼₖ may represent the combined effect of a question-based weighting vₖ and a judge-based weighting vⱼ:

vⱼₖ=f(vⱼ, vₖ) (15)

If the question-based factors are independent of the judge-based factors, then vⱼₖ=vⱼvₖ. More particularly, if tuning is purely question-based, vⱼₖ=vₖ.

As will be appreciated, Equation (14) may be conveniently represented in a matrix/vector form:

$${r}_{s}^{0} = \frac{1}{JK} {Vr}_{sj} \qquad ( 16 )$$

In Equation (16):

$$V = ( \begin{matrix}{v}_{11} & {v}_{12} & … \\ {v}_{21} & {v}_{22} & \\ ⋮ & & ⋱\end{matrix} ) ; \\ {r}_{sj} = ( \begin{matrix}{R}_{sj} ( 1 ) \\ {R}_{sj} ( 2 ) \\ ⋮\end{matrix} ) \qquad ( 12 )$$

Consequently, the result in Equation (14) can be expressed as the sum of elements of the vector r⁰ₛ:

Rₛⱼ^{w,0}=Tr(Iₖrₛ⁰) (17)

A ‘zeroth-order’ confidence measure C⁰ₛ for a rating provided by a set of size J of judges {j} for a subject s may be defined, in general terms, as a function of one or more confidence factors C⁰_{x,s}:

$${C}_{s}^{0} = f ( {C}_{n , s}^{0} , {C}_{f , s}^{0} , … ) \qquad ( 18 )$$

Equation (18) includes two exemplary confidence factors, C⁰_{n,s} representing a contribution of the number nₛ of ratings received by the subject (based on the evident fact that a larger number of judges will result in a more reliable rating), and C⁰_{f,s} representing an effect of familiarity on confidence (based on the evident fact that judges with more experience of a subject will produce more reliable ratings).

For example, these confidence factors may be combined according to a geometric averaging procedure, with relative weights wₙ and w_{f} respectively, i.e.:

$${C}_{s}^{0} = {[ {( {C}_{n , s}^{0} )}^{{w}_{n}} \cdot {( {C}_{f , s}^{0} )}^{{w}_{f}} ]}^{1 / ( {w}_{n} + {w}_{f} )} \qquad ( 19 )$$

In some embodiments, equal weightings may be applied, i.e. wₙ=w_{f}=0.5.

By way of example, a number-based confidence factor may be computed according to the general formula:

$${C}_{n , s}^{0} = 1 - B {e}^{- ( {n}_{s} + m ) / N} \qquad ( 20 )$$

In Equation (20), the parameters N, B and m together control the rate of decline in confidence as the number of available ratings reduces. In one particular embodiment, values of N=2.8853, B=2 and m=1 have been employed.

A familiarity-based confidence factor may be computed according to the formula:

$${C}_{f , s}^{0} = \frac{1}{J} {\sum }_{j} \frac{{F}_{sj}}{{F}_{max}} \qquad ( 21 )$$

Alternatively, or additionally, a ‘first-order’ familiarity-based confidence factor may be computed, taking into account the judge rating W⁰ᵢ and the (zeroth-order) confidence in the judge's rating C⁰ᵢ for each judge i:

$${C}_{s}^{1} = {C}_{n , s}^{0} \cdot {\sum }_{i} \frac{{F}_{si}}{{F}_{max}} \cdot {W}_{i}^{0} \cdot {C}_{i}^{0} \qquad ( 22 )$$

An additional confidence factor that could be taken into account in Equation (18) is a relationship-based factor, reflecting the fact that some types of relationships between rater and ratee are more likely to result in reliable and objective ratings. One way in which such a relationship-based factor could be determined is by providing a selection of relationships in response to the question 702 in the questionnaire of FIG. 7, and assigning a score to each relationship category, e.g. ‘friend’ (1), ‘junior or professional acquaintance’ (2), ‘peer or customer’ (3), ‘senior or group peer’ (4), ‘direct supervisor’ (5).

Defining the available relationship values by Pₛⱼ and the maximum (most reliable) relationship value as Pₘₐₓ, a relationship factor can then be computed by analogy with the familiarity-based factor as:

$${C}_{r , s}^{0} = \frac{1}{J} {\sum }_{j} \frac{{P}_{sj}}{{P}_{max}} \qquad ( 23 )$$

For combination by geometric averaging, a weighting wᵣ may also be defined, and Equation (19) extended in the normal manner. For example, equal weightings wₙ=w_{f}=wᵣ=⅓ may be employed.

1. A method of providing a rating for an entity within a network of entities, the method comprising:
receiving, from a ratee entity requiring a rating, a message comprising a nomination of one or more rating entities;
presenting to each of said one or more rating entities a message comprising a request to respond to a plurality of questions in relation to the ratee entity, each said question requiring a response according to a rating scale;
receiving, from each of said one or more rating entities, a corresponding response, each response comprising a plurality of response scores corresponding with the plurality of questions, each response score being in accordance with the rating scale;
computing a qualification measure for each of said rating entities, the qualification measure comprising one or more of a capability measure, a bias measure and a familiarity measure;
computing, for each of said one or more rating entities, a rating score for the ratee entity based upon the response scores and the qualification measure of the rating entity; and
computing an overall rating score of the ratee entity based upon the computed rating scores of said one or more rating entities.

2. The method of claim 1 wherein the plurality of questions address a plurality of characteristics of the ratee entity as judged from the perspective of each rating entity.

3. The method of claim 2 wherein the characteristics are selected from a group comprising: competency; ethics; reliability; motivation; leadership; resilience; collaboration; receptiveness; and recommendability.

4. The method of claim 1 wherein the plurality of questions comprise one or more questions relating to familiarity of each rating entity with the ratee entity.

5. The method of claim 4 wherein the response score corresponding with the one or more questions relating to familiarity is used to compute the familiarity measure.

6. The method of claim 1 wherein computing an overall rating score comprises calculating an average of the rating scores of each of said one or more rating entities.

7. The method of claim 1 wherein computing a rating score of the ratee entity corresponding with a rating entity comprises calculating a weighted sum of the response scores of the rating entity, wherein a weighting value applied to each response score is based upon the qualification measure of the rating entity.

8. The method of claim 7 wherein the qualification measure comprises a product of two or more of the capability measure, the bias measure and the familiarity measure.

9. The method of claim 7 wherein the weighted sum comprises a sum of a product of the qualification measure and the response scores of the rating entity.

10. The method of claim 7 wherein the weighting value applied to each response score is further based upon a question weighting associated with a corresponding one of the plurality of questions.

11. The method of claim 1 wherein computing a rating score of the ratee entity corresponding with a rating entity comprises calculating a weighted sum of the response scores of the rating entity, wherein a weighting value applied to each response score is based upon the rating entity and a corresponding one of the plurality of questions.

12. The method of claim 1 wherein the qualification measure comprises a plurality of qualification measures, each one of said qualification measures corresponding with one of the plurality of characteristics of the ratee entity.

13. The method of claim 1 wherein the capability measure is based upon a previously computed overall rating score of the corresponding rating entity.

14. The method of claim 13 wherein the capability measure of the rating entity is based upon the previously computed overall rating score of the rating entity relative to previously computed overall rating scores of all of the rating entities.

15. The method of claim 1 wherein the bias measure is based upon a plurality of bias measures obtained by comparing response scores provided by the corresponding rating entity in relation to each one of a plurality of previously rated ratee entities with response scores provided by other rating entities in relation to the plurality of previously rated ratee entities.

16. The method of claim 15 wherein the bias measure comprises an average of a set of ratios of response scores provided by the rating entity in relation to each one of the plurality of previously rated ratee entities to an average of corresponding response scores provided by the rating entity and the other rating entities in relation to said one of the plurality of previously rated ratee entities.

17. The method of claim 1 which further comprises computing a confidence measure associated with the overall rating score.

18. The method of claim 17 wherein the confidence measure is based upon a number of rating entities that have provided responses in relation to the ratee entity.

19. The method of claim 17 wherein the confidence measure is based upon the familiarity measures of the rating entities that have provided responses in relation to the ratee entity.

20. The method of claim 17 wherein the confidence measure is based upon a combination of:
the number of rating entities that have provided responses in relation to the ratee entity; and
the familiarity measures of the rating entities that have provided responses in relation to the ratee entity.

21. The method of claim 17 wherein the confidence measure is based upon a confidence measure of one or more of the rating entities.

22. The method of claim 17 wherein the confidence measure is based upon a relationship measure associated with a relationship between a rating entity and the ratee entity.

23. The method of claim 1 further comprising re-computing an overall rating score of each entity in the network of entities for which the ratee entity has previously acted as a rating entity.

24. The method of claim 23 further comprising repeating said re-computing one or more times.

25. A server for providing a rating for an entity within a network of entities, the server comprising:
at least one processor;
at least one non-volatile storage device accessible by the processor and comprising a database which contains entity records, each of which includes information relating to a corresponding entity, and which are adapted to contain information relating to ratings provided by the corresponding entity to other entities in the network, and information relating to ratings of the corresponding entity provided by other members of the professional network;
at least one computer-readable memory device operatively associated with the processor; and
a data communications interface operatively associated with the processor and configured to communicate with client devices associated with entities in the network of entities,
wherein the memory device contains computer-executable instruction code which, when executed via the processor, causes the processor to effect a method comprising steps of:
receiving, from a ratee entity requiring a rating, a message comprising a nomination of one or more rating entities;
presenting to each of said one or more rating entities a message comprising a request to respond to a plurality of questions in relation to the ratee entity, each said question requiring a response according to a rating scale;
receiving, from each of said one or more rating entities, a corresponding response, each response comprising a plurality of response scores corresponding with the plurality of questions, each response score being in accordance with the rating scale;
computing a qualification measure for each of said rating entities, the qualification measure comprising one or more of a capability measure, a bias measure and a familiarity measure;
computing, for each of said one or more rating entities, a rating score for the ratee entity based upon the response scores and the qualification measure of the rating entity;
computing an overall rating score of the ratee entity based upon the computed rating scores of said one or more rating entities; and
storing information relating to the computed overall rating score in an entity record in the database corresponding with the ratee entity.
